(19) United States
(12) Patent Application Publication
(10) Pub. No.: US 2008/0222693 A1
(43) Pub. Date: Sep. 11, 2008

(54) Multiple security groups with common keys on distributed networks

(75) Inventor: Donald K. McAlister, Apex, NC (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: CipherOptics, Inc., Raleigh, NC (US)

(21) Appl. No.: 11/888,620

(22) Filed: Aug. 1, 2007

Related U.S. Application Data
(60) Provisional application No. 60/836,173, filed on Aug. 8, 2006.

(51) Int. Cl. G06F 21/00; G06F 15/16

(52) U.S. Cl. 726/1

(57) ABSTRACT

A technique for securing message traffic in a data network using a protocol such as IPsec, and more particularly, various methods for distributing security policies among peer entities in a network while minimizing the passing and storage of detailed policy or key information except at the lowest levels of a hierarchy.

### RELATED APPLICATION

This application claims the benefit of U.S. Provisional Application No. 60/836,173, filed on Aug. 8, 2006. The entire teachings of the above referenced applications are incorporated herein by reference.

### BACKGROUND OF THE INVENTION

The present invention relates to securing message traffic in a data network, and relates more particularly to how security policies are configured.

The following definitions are used in this document:

“Securing” implies both encryption of data in transit as well as authenticating that the data has not been manipulated in transit.

A “secure tunnel” between two devices ensures that data passing between the devices is secure.

The “security policies” for a secure tunnel define the traffic to be secured by source and destination IP address, port, and/or protocol. They also define the type of security to be performed.

A “key” for a secure tunnel is the secret information used to encrypt and decrypt (or authenticate and verify) the data in one direction of traffic in the secure tunnel.

A “Policy Enforcement Point” (PEP) is a device that secures the data based on the policy.

### Existing Network Security Technology

According to the most commonly used computer networking protocols, network traffic is normally sent unsecured without encryption or strong authentication of the sender and receiver. This allows the traffic to be intercepted, inspected, modified, or redirected. As a result, either the sender or receiver can falsify their identity. In order to allow private traffic to be sent in a secure manner, a number of security schemes have been proposed and are in use. Some are application dependent, as with a specific program performing password authentication. Others, such as Transport Layer Security (TLS), are designed to provide comprehensive transport layer security such as the HTTP (web) and FTP (File Transfer Protocol) level.

Internet Protocol Security (IPsec) was developed to address a broader security need. As the majority of network traffic today is over Internet Protocol (IP), IPsec was designed to provide encryption and authentication services to this traffic regardless of the application or transport layer protocol. This is done, in a so called IPsec tunnel mode, by encrypting a data packet (if encryption is required), performing a secure hash (authentication) on the packet, then wrapping the resulting packet in a new IP packet indicating it has been secured using IPsec.

The secret keys and other configuration data required for this secure tunnel must be exchanged by the parties involved to allow IPsec to work. This is typically done using Internet Key Exchange (IKE). IKE key exchange is done in two phases.

In a first phase (IKE Phase 1), a connection between two parties is started in the clear. Using public key cryptographic mechanisms, where two parties can agree on a secret key by exchanging public data without a third party being able to determine the key, each party can determine a secret for use in the negotiation. Public key cryptography requires each party either share secret information (pre-shared key) or exchange public keys for which they retain a private, matching, key. This is normally done with certificates (Public Key Infrastructure or PKI). Either of these methods authenticates the identity of the peer to some degree.

Once a secret has been agreed upon in IKE Phase 1, a second phase (IKE Phase 2) can begin where the specific secret and cryptographic parameters of a specific tunnel are developed. All traffic in phase 2 negotiations are encrypted by the secret from phase 1. When these negotiations are complete, a set of secrets and parameters for security have been agreed upon by the two parties and IPsec secured traffic can commence.

When a packet is detected at a Security Gateway (SGW) with a source/destination pair that requires IPsec protection, the secret and other Security Association (SA) information are determined based on the Security Policy Database (SPD) and IPsec encryption and authentication is performed. The packet is then directed to an SGW that can perform decryption. At the receiving SGW, the IPsec packet is detected, and its security parameters are determined by a Security Packet Index (SPI) in the outer header. This is associated with the SA, and the secrets are found for decryption and authentication. If the resulting packet matches the policy, it is forwarded to the original recipient.

Problems with the Prior Art

Although IPsec tunnel mode has been used effectively in securing direct data links and small collections of gateways into networks, a number of practical limitations have acted as a barrier to more complete acceptance of IPsec as a primary security solution throughout the industry.

One such problem results from need to configure security policies. Members in a secure network, either individuals or subnets, often want secure communication to a few other individuals, either locally or remotely. This network security functions typically allow for defining security policies that specify Security Groups (SGs). Each SG has member individuals or subnets that are permitted access to one another. However, configuration of the security policies to enforce this is challenging and requires a local administrator to have detailed knowledge of remote networks, or for a global security administrator to have authorization to configure all units.

### SUMMARY OF THE INVENTION

### Problem Solution Using Local Distribution of Security Policies

The present invention is a method for configuring and distributing Security Group information to security policy enforcement points automatically, such that only knowledge of local network configuration is required, while still preserving group security functionality.

More specifically, a Security Group (SG) definition is provided, where the SG is a list of associated nodes that are intended to communicate with one another securely, and other security policy information, such as encryption information. A Policy Distribution Point (PDP) and Policy Enforcement Point (PEP) are separate entities in each network location. The PEPs are responsible for enforcing security policies on message traffic. The PDPs receive SG definitions and exchange information about SGs with other PDPs in other remote network locations using secure communication protocols. During this exchange, the PDPs identify SGs by an identifier of the network protected, and not specific node addresses. In this manner, node IDs information need only be maintained locally, and yet secure communication is possible across a wide area network.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a system level diagram of an approach that permits automatic configuration of local security policies automatically, while preserving group level security. The technique uses Policy Distribution Points (PDPs) and Policy Enforcement Points (PEPs).

FIG. 2 is a flow chart of steps performed by the system of FIG. 1.

FIG. 3 is a data flow diagram of data sent to and received by an example Policy Distribution Point (PDP).

### DETAILED DESCRIPTION OF THE INVENTION

A description of a preferred embodiment of the invention follows.

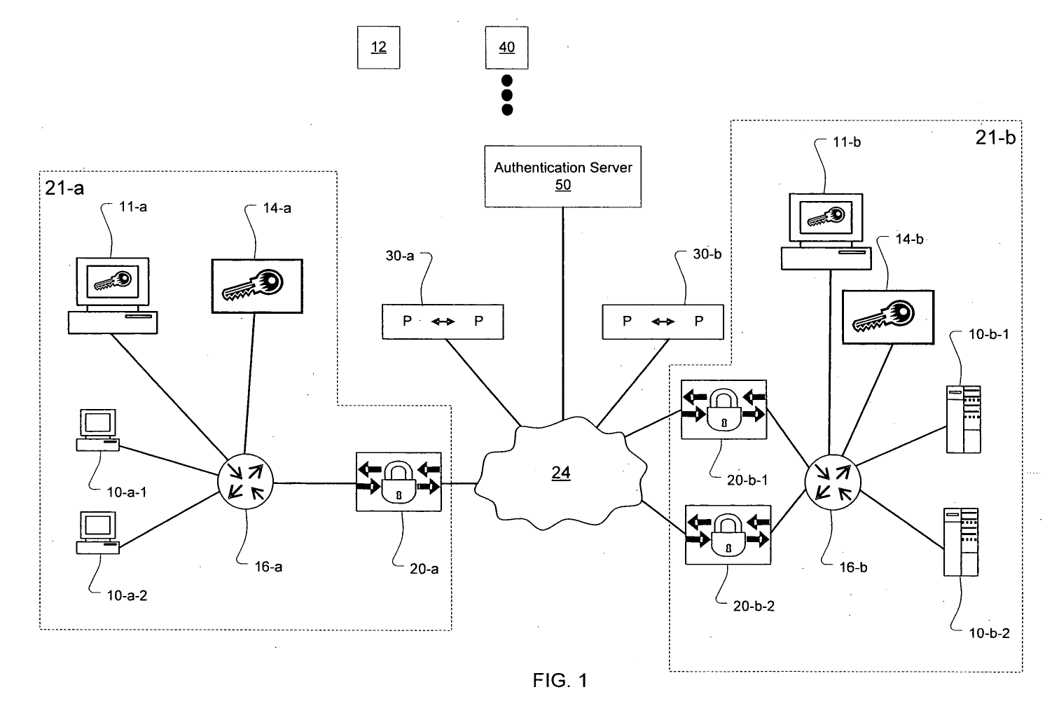

FIG. 1 illustrates a wide area data communications network where the invention may be implemented. A given network location 21-a in the network generally has a number of data processors and functions including nodes (end nodes) 10-a-1, 10-a-2, Security Manager (SM) 11-a, a Key Generation and Distribution Point (KGDP) 14-a, an internetworking device 16-a such as may include one or more routers or switches, a Policy Enforcement Point (PEP) function 20-a and Policy Distribution Point (PDP) function 30-a. The typical network has at least one other network location 21-b that implements nodes 10-b-1, 10-b-2, SM 11-b, KGDP 14-6, PEP 20-b-1, 20-b-2, PDP 30-b.

Network locations 21-a and 21-b may be subnets, physical LAN segments or other network architectures. What is important is that the network locations 21-a and 21-b are logically separate from one another and from other network locations 21. A network location 21 may be a single office of an enterprise that may have only several computers, or a network location 21 may be a large building, complex or campus that has many, many different machines installed therein. For example, network location 21-a may be in a west coast headquarters office in Los Angeles and network location 21-b may be an east coast sales office in New York.

The nodes 10-a-1, 10-a-2, 10-b-1, 10-b-2 . . . (collectively, nodes 10) in any network location 21 can be typical client computers such as Personal Computers (PCs), workstations, Personal Digital Assistants (PDAs), digital mobile telephones, wireless network enabled devices and the like. The nodes 10 can also be file servers, video set top boxes, other data processing machines, or indeed any other networkable device from which messages originate and to which message are sent. The message traffic typically takes the form of data packets in the well known Internet Protocol (IP) packet format. As is well known in the art, an IP packet may typically be encapsulated by other networking protocols such as Transmission Control Protocol (TCP), User Datagram Protocol (UDP), or other lower level and higher level networking protocols.

Each network location 21 has a Security Manager (SM) 11 that is a data processing device, typically a PC or workstation, through which an administrative user can input and configure security policies 12. The SM 11 also acts as a secure server to store and provide access to such security policies 12 by other elements of the system. As will be explained more fully below, the Key Generation and Distribution Points (KGDP) 14, Policy Distribution Points (PDPs) 30, and Policy Enforcement Points (PEPs) 20 cooperate to secure message traffic between the nodes 10 according to security policies 12.

More particularly, a KGDP 14 is responsible for generating and distributing “secret data” known as encryption keys upon request. The keys are then used as a basis to derive other keys that are used for transmission of traffic over secure tunnels from one end node 10 to another end node 10, to perform authentication, and other functions.

The PEPs 20 are located on the data path, and can typically be instantiated as a process running on a Secure Gateway (SGW) at each network location 21. The PEPs enforce security policies 12. The PEPs 20 have a packet traffic or “fast path” interface on which they receive and transmit the packet traffic they are responsible for handling. They also have a management interface over which they receive configuration information, and other information such as security policies 12 and encryption keys. The SGW in which the PEPs 20 run can be configured to perform additional functions typically of IP network gateways such as Network Address Translation (NAT), packet fragmentation handling, and the like. It should be understood that the PEPs 20 may also be installed on other internetworking devices, and that the choice of an SGW in the preferred embodiment is but one example

In general, traffic between the modules described above is either local (within a single device) or protected by a secure tunnel in a wide area network 24 that provides the wide area connections between network locations 21. Management of each device is also via a secure tunnel and with a secure user authentication. Also, and for highly resilient implementation is required, each module must itself be resilient and if a state is stored, a method for exchanging state and performing switch over must be implemented.

The PEPs 20 are responsible for a number of tasks. They are principally responsible for performing encryption of outbound packets and decryption of inbound packets received on the fast path interface. The PEPs 20 can thus identify packets that need to be secured according to configured security policies 12. The PEPs 20 can also typically be programmed to pass through or drop such packets according to such security policies 12.

The PEPs 20 are also configured to perform IPsec tasks such as handling Security Association (SA) information as instructed by the SM 11, to store and process Security Packet Index (SPI) data associated with the IPsec packets, and the like. The PEPs 20 thus perform many (if not all) of the IPsec security gateway functions as specified in IPsec standards such as Internet Request for Comments (RFCs) 2401-2412.

The SM 11, the PEP 20, PDP 30, and KGDP 14 perform and/or participate in several security related functions including:
key generation
key distribution
policy definition (generation)
policy distribution (local and remote)

These functions are now discussed briefly, before continuing with detailed examples of how local security policies are handled according to the present invention. Further details of a preferred embodiment of these functions is contained in a co-pending U.S. Provisional Patent Application No. 60/756,765 entitled SECURING NETWORK TRAFFIC USING DISTRIBUTED KEY GENERATION AND DISSEMINATION OVER SECURE TUNNELS, filed Jan. 6, 2006, assigned to CipherOptics, Inc., and which is hereby incorporated by reference in its entirety.

Key Generation. This module creates keys to secure a given tunnel. As in IKE this is done in coordination with a single peer as each side agrees on outbound and inbound keys. However, in the embodiment of the present invention, this might also be a single unit that generates keys for traffic between a number of units. It may also be embodied in a single PEP generating a key for outbound traffic on a given tunnel.

Key Distribution. This module ensures that all connections to the tunnel have keys necessary to decrypt and encrypt data between the end points. As mentioned previously, this is done in standard IKE as part of the “Phase 2” key exchange between two peers. However, in the present invention, as will be described in several detailed examples shortly, this is performed by the PEPs exchanging keys in other ways. With these techniques, key distribution is still securely protected to prevent eavesdropping, tampering, and to ensure that the exchange occurs with an authorized party.

The Key Generation and/or Key Distribution modules may be located on individual stand alone machines, or may be incorporated together within a Key Generation and Distribution Point (KGDP). In addition, Key Distribution may be co-located with the PEP 20 in other architectures.

Local Policy Definition (also called “Policy Generation” herein). This module maintains information on IP addresses, subnets, ports or protocols protected by the PEP 20. It can be implemented in numerous ways. It may be part of a security policy definition 12 for nodes 10 in each network location 21 as specified by a local SM 11. The local policy definition can also be limited to a collection of subnets protected by a certain PEP 20. Or it can simply relate to and be stored at a single IP address, such within the network software on a node (remote access client) 10 (for example, MICROSOFT WINDOWS and other operating systems provide certain tools for specifying security policies 12). Policy definition can also occur via a discovery process performed by a PEP 20. If a complete security policy definition is not present, it should also include information to link the protected local traffic to its secure destinations.

### Policy Distribution According to a Convenient Embodiment

Security policies for a given network location 21 may thus originate from many sources, but their distribution in a given network location is the responsibility of an associated Policy Distribution Point (PDP) 30. The present invention relates to configuring local security policies automatically such that only local policy knowledge is required by a PDP 30, while still preserving security across the entire wide area network. In other words, each PDP only need maintain detailed security information about the nodes 10 at its own local network location 21, and need not know such details about remote network locations 21.

More particularly, note that in the illustrated system, a number of data processing machines are associated with a first network location 21-a including first node (host) 10-a-1, second node 10-a-2, a first Security Manager (SM) 11-a, a first Key Generation and Distribution Point (KGDP) 14-a, one or more internetworking devices 16-a, and a first Policy Enforcement Point (PEP) 20-a.

In addition, a first Policy Distribution Point, (PDP) 30-a, which is preferably physically located within the confines of the first network location 21-a, is responsible for distributing security policies 12 to and from the data processors at the first network location 21-a in a manner that will be described below.

Similarly, a second network location 21-b has other data processing machines such as a first node that happens to be a file server 10-b-1, second file server 10-b-2, an associated Security Manager (SM) 11-b, KGDP 14-b, and internetworking devices 16-b. Location 21-b may, for example, be a high availability web and/or storage server and thus has multiple PEPs 20-b-1 and 20-b-2. As with network the first location 21-a, a second Policy Distribution Point (PDP) 30-b is associated with and responsible for security policies distributed to and from the second location 21-b.

The reader will recall that “security policies” 12 can define traffic to be secured by source and destination, IP address, port and/or protocol, and Security Groups (SG) 40. A security policy 12 also defines the type of security to be applied to a particular connection. Each policy definition 12 can, in a preferred embodiment, be limited to a certain collection of subnets such as those at the first network location 21-a that are under control of a local administrator there.

The policy definitions 12 can be created by a user entering the pair of IP addresses via an administrative user command interface. However, security policies 12 can also be defined using certain features of Microsoft Windows and similar operating systems that provide certain tools for specifying security policies for each node 10.

An Authentication Server 50 can be used to distribute security policies 12 and information concerning SG membership between PDPs 30 and PEPs 20, in a manner to be described below. The Authentication Server 50, cooperating with the Security Managers 11 (SM), or the SMs 11 themselves configure SG policy information at one or more of the PEPs 20, PDPs 30 and/or KGPDs 14.

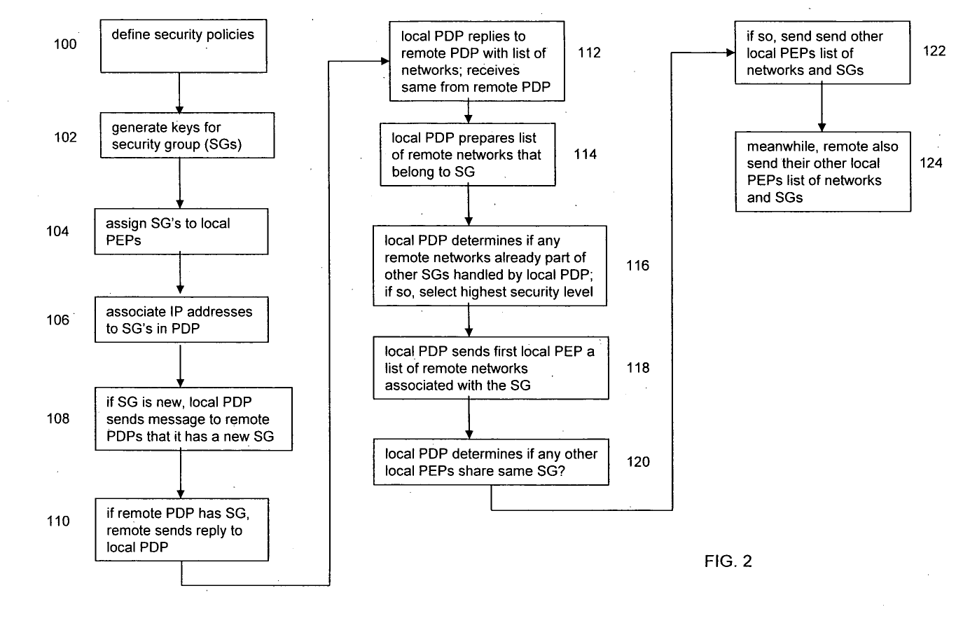

As the PEPs 20 must carry out security policies 12 in handling the traffic they see, the PEPs 20 need to have access to security policies 12, including not only security policies for their respective local network location 21 traffic, but also concerning remote traffic to be directed to other network locations 21. The present invention thus provides a scheme for distributing such information to a local PEP 20-a from its associated PDP 30-a. From the perspective of the overall system, one embodiment of the present invention has multiple steps as shown in FIG. 2.

Step 100. Security Policies 12 are defined locally that associate nodes 10 to Security Groups (SGs) 40. A typically installation will have many SGs 40 defined for each of many different network locations 21-a and 21b. This information may be maintained in a local Security Manager (11-a in the case of network location 21-a, and 11-b in the case of network location 21-b, etc.), or distributed by a centralized Authentication Server 50. Here let us assume that a node 10-a-1 is part of a Security. Group 40 that includes one other local node 10-a-2 and a remote node 10-b-1. A policy 12 is created at network location 21-a to associate node 10-a-1 and node 10-a-2 to SG 40. Information concerning the membership of remote node 10-b-1 need not be provided to local SM 11-a for location 21-a. However, another policy 12 is also created at network location 21-b to associate node 10-b-1 to SG 40. That policy 12 at network location 21-b need not specify the nodes (members) (10-a-1 and 10-a-2) of the SG at other network locations 21.
Step 102. A separate key is generated for each SG 40 by respective local KGDPs 14 to secure outbound traffic. This permits secure transmission of packets between network locations 21-a and 21-b. The specific manner of doing so is not critical to the present invention; one may refer to the pending provisional patent referenced above for one suitable method.
Step 104. Policy Enforcement Point (PEP) units 20-a, 20-b-1, 20-b-2 are then assigned a list of SGs 40 to which they belong along with associated local nodes (end points) 10-a-1 and 10-a-2. This can be done by manual configuration or by the PEP 20 receiving a secure message from the Authentication Server 50 or from direct from a local Security Manager (SM) 11-a or in a number other ways. For example, outbound traffic may trigger request for information from local SM 11-a or Authentication Server (AS) 50, it may receive direct updates from the AS 50, or as a result of some combination of the above events.
Step 106. Next, a particular PEP 20-a joins its local network 21-a. The local PDP 30-a is informed by the particular PEP 20-a of the local IP addresses protected by the local PEP 20-a and the Security Groups (SGs) 40 to which the PEP 20-a belongs. This information can be originally set in the PEP 20-a and sent to the PDP 30-a, configured in the PDP 30-a, or sent by the authentication server 50 to the PDP 30-a.
Step 108. The PDP 30-a then checks if it has already handled the SG 40 previously. If not, it sends a message to all other PDP units 30 (including PDP 30-b) that it knows of to let them know it has a new SG 40. So in the example being discussed, PDP 30-a will send a message to PDP 30-b that it has a new SG 40-a. Other details of the new SG need not be provided to the remote PDP 30-b, however.
Step 110. If any remote PDP 30 also has the same SG, it replies to the local PDP 30-a. In a convenient embodiment, the local PDP 30-a is informed of a remote representation of the SG in response to informing the at least one remote PDP 30. The remote representation of the SG has at least one remote network identifier which identifies the at least one remote network within which the at least remote node is located, but lacks the representation of the at least one remote node which identifies the at least one remote node. In the example being discussed, remote PDP 30-b replies to PDP 30-a that the network location 21-a has a Security Group 40. Again, no details of group membership are exchanged.
Step 112. The local PDP 30-a replies to remote PDP 30-b with a list of the networks protected by its local PEP 20-a and the address of the local KGDP for key distribution. The local PDP 30-a receives that same from the remote PDP 30-b.
Step 114. The local PDP 30-a prepares a list of networks remote to the PEP 20-a associated with the various SGs (e.g., 40-a) to which the PEP 20-a belongs.
Step 116. The local PDP 30-a determines if the remote networks (21-b) protected by the remote PEPs 20-b-1, 20-b-2 belong to other SGs 40 that it knows of. Where the local network location 21-a and remote network location 21-b belong to multiple SGs 40, the local PDP 30-a chooses the highest security level SG to use for that pair.
Step 118. The local PDP 30-a obtains keys for the SG then sends its first local PEP 20-a a list of remote protected networks associated with the various Security Groups (SG 40 in the example being discussed) and the associated keys.
Step 120. The local PDP 30-a also determines if there are other independent, local PEPs protecting networks that share the same Security Groups. Again, the highest security level SG is chosen.
Step 122. The local PDP 30-a sends any other local PEP 30 a list of networks protected by the first PEP and their associated Security Groups and keys.
Step 124. The remote PDPs 30-b send their local PEPs 20-b-1, 20-b-2, the new list of networks protected by the first PEP 20-a and their associated Security Groups 40.

Note that when configuring security policies in a local network, the Security Manager (SM) 11-a only needs to know the subnets and Security Group (SG) 40 requirements of that network and the identities of remote PDP units. The identities of remote nodes 10-b-1, 10-b-2, etc. need not be specified.

The PDPs 30-a, 30-b can also be configured in a tiered fashion where the local PDP inquires up a hierarchy to discover the complete network policy requirements. This configuration avoids the need for a centralized Authentication Server 50. See, for example, the approach for Security Policy Managers described in a co-pending U.S. Provisional Patent Application Ser. No. 60/813,766 entitled SECURING NETWORK TRAFFIC BY DISTRIBUTING POLICIES IN A HIERARCHY OVER SECURE TUNNELS, filed Jun. 14, 2006, which is hereby incorporated by reference.

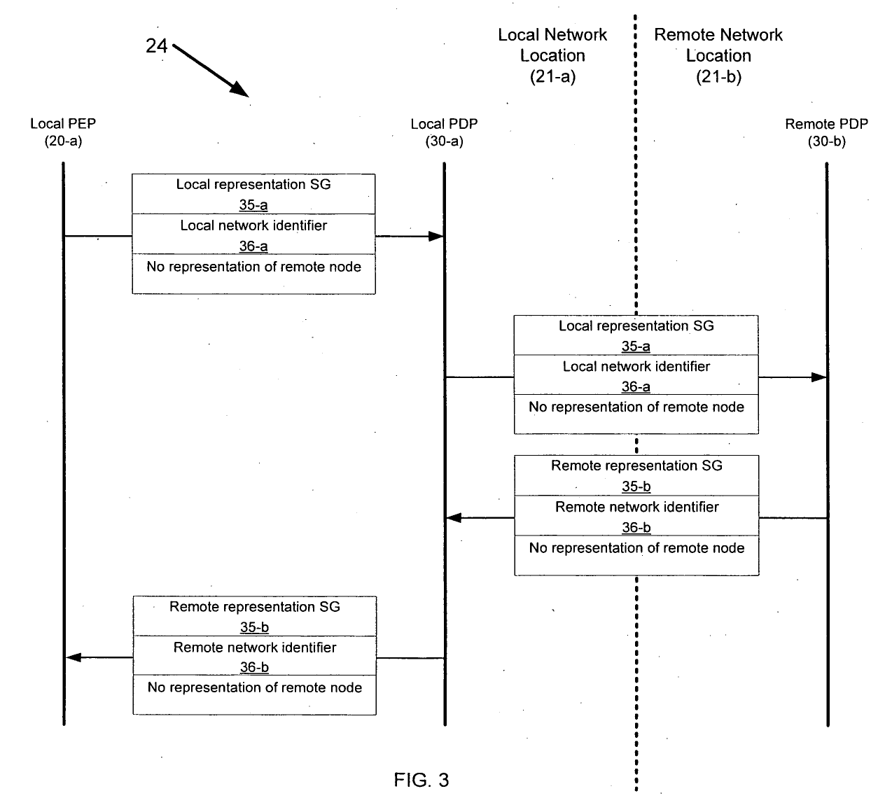

FIG. 3 is a data flow diagram illustrating data sent to and received by a local Policy Distribution Point (PDP) 30-a. The data network 24 includes a local network location 21-a with a local node located therein and at least one remote network location 21-b with at least one remote node located therein. The local node and the at least one remote node are associated with and are members of at least one Security Group (SG).

Located within the local network location 21-a, a local Policy Distribution Point (PDP) 30-a determines that a new local representation of the SG (“local SG representation”) 35-a. exists. The local SG representation 35-a includes a local network identifier 36-a, for example, a network ID or network address, which identifies the local network location 21-a within which the local node is located. At this point, the local SG representation 35-a, however, lacks a representation of the remote node, for example, a Host ID or host address, which identifies the remote node.

The local PDP 30-a sends the local SG representation (a request message) 35-a to a remote PDP 30-b. The remote PDP 30-b is associated with the remote network location 21-b. By sending the local SG representation 35-a, the local PDP 30-a informs the remote PDP 30-b of the local network identifier 36-a, which identifies the local network location 21-a within which the local node is located. The local PDP 30-a may have informed the remote PDP 30-b of the local network identifier 36-a previously. Alternatively, another local PDP may have informed the remote PDP 30-b of the local network identifier 36-a previously. As such, it may be convenient for the local PDP 30-a to inform the remote PDP 30-b in an event the local SG representation has not been distributed in the local network location 21-a previously.

Note that the local PDP 30-a informs the remote PDP 30-b by way of the local SG representation 35-a. Recall that the local SG representation 35-a includes the local network identifier 36-a which identifies the local network location 21-a within which the local node is located. Also recall that the local SG representation 35-a, however, lacks a representation of the remote node identifying the remote node. As such, regarding details of SG membership, such as the representation of the remote node (and for that matter, a representation of the local node), the local PDP 30-a need not inform or otherwise provide such details to the remote PDP 30-b. In this way, the local PDP 30-a maintains detailed security information about nodes within its own network location, i.e., the local network location 21-a, and need not know such details about network locations “remote” relative to the local network location 21-a, such as the remote network location 21-b.

The local PDP 30-a is receives a remote representation of the SG (“remote SG representation”) (a reply message) 35-b from the remote PDP 30-b. The remote SG representation 35-b includes a remote network identifier 36-b, which identifies the remote network location within which the remote node is located. The remote SG representation 35-b, however, lacks the representation of the remote node which identifies the remote node. The local PDP 30-a is informed by the remote PDP 30-b in response to informing the remote PDP 30-b. Again, regarding details of SG membership, such as the representation of the remote node, the local PDP 30-a need not be informed by the remote PDP 30-b of such details. In this way, the remote PDP 30-b maintains detailed security information about nodes within its own network location, i.e., the remote network location 21-b, and need not know such details about network locations “remote” relative to the remote network location 21-b, such as the local network location 21-a.

In example embodiment, in receiving the remote SG representation 35-b from the remote PDP 30-b, the local PDP 30-a determines whether the remote network location 21-b identified by the remote representation of the SG belongs to at least one other SG. The local PDP 30-a then chooses the SG with a highest security level in an event the remote network location 21-b belongs to both the SG and the SG with the highest security level.

As FIG. 3 illustrates, PDPs, such as the local PDP 30-a and the remote PDP 30-b receive SG definitions (e.g., the local SG representation 35-a and the remote SG representation 35-b) and exchange information about SGs with other PDPs in other “remote” networks locations (e.g., the local network location 21-a and the remote network location 21-b). During this exchange, the PDPs identify SGs by an identifier of the network protected, such as the local network identifier 36-a and the remote network identifier 36-b, and not by specific node addresses (e.g., a Host ID and host address). In this manner, information regarding individual nodes, such as a representation of a node which identifies the node, need only be maintained locally and yet secure communication is possible across a wide area network.

Continuing to refer to FIG. 3, the local PDP 30-a distributes the remote SG representation 35-b and the remote network identifier 36-a to at least one Policy Enforcement Point (PEP) located within the local network location 21-a, such as the local PEP 20-a. The distributed remote SG representation 35-b enables the local PEP 20-a to secure communications between the local node and the remote node.

In a convenient embodiment, in distributing the remote SG representation 35-b, the local PDP 30-a determines which other local PEPs located within the local network location 21-a protect networks which share the same SG. The local PDP 30-a then distributes the remote SG representation 35-b to the determined other local PEPs.

As FIG. 3 illustrates, example embodiments of the present invention maintain detailed security information about nodes located within a network location i.e., “locally.” However, such details about network locations that are “remote,” relative to the network location, need not be known. Furthermore, Security Group (SG) definitions are exchanged by between local and remote network locations without identifying members of the SG. In this way, and in accordance with example embodiments of the present invention, configuring security policies neither requires a local administrator to have detailed knowledge of remote networks nor for a global security administrator to have authorization to configure all security elements.

While this invention has been particularly shown and described with references to preferred embodiments thereof, it will be understood by those skilled in the art that various changes in form and details may be made therein without departing from the scope of the invention encompassed by the appended claims.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A method for securing message traffic in a data network by distributing security policies, the data network comprising a local network location having at least one local node located at the location, and a remote network location having at least one remote node, the local and remote nodes being members of at least one Security Group (SG), the SG also including a network identifier for the location of the local node and a network identifier for the location of the remote node, the method comprising the steps of, carried out at a local Policy Distribution Point (PDP) associated with one of the local network locations:
determining that a new local SG representation exists, the local SG representation including a network identifier for local nodes in the SG but not including a representation of the remote node in the SG;
sending a request message from the local PDP to a remote PDP associated with the remote network location to inform the remote PDP of receipt of a new SG representation, the request message including an identifier of the SG but not identities of the members of the SG;
receiving a reply message from a remote PDP, the reply including a remote network identifier for remote nodes associated with the remote PDP without identifying the remote node; and
distributing the local SG representation and the remote network identifier to a local Policy Enforcement Point (PEP), to enable the local PEP to apply security functions to traffic between the local and remote nodes.

2. The method of claim 1 wherein the step of determining the new SG exists comprises sending a first message to the remote PDP informing the remote PDP that the local SG representation has not been distributed in the local network location previously.

3. The method of claim 1 wherein the step of determining the new SG exists comprises maintaining at a local Policy Distribution Point (PDP) associated with local network location the identity the remote PDP associated with the remote network location.

4. The method of claim 1 wherein the step of receiving the reply message comprises receiving in response to a first message, a second message from the remote PDP informing a local PDP associated with local network location that the remote PDP distributes the remote SG representation in the remote network location.

5. The method of claim 1 wherein the step of receiving the reply message comprises:
determining whether the remote network location identified by the remote SG representation belongs to at least one other SG; and
choosing the SG with a highest security level in an event the least one remote network location belongs to both the SG and the SG with the highest security level.

6. The method of claim 1 wherein the step of distributing the local SG representation and the remote network identifier comprises:
determining which other local PEPs located within the local network location protect networks which share the same SG; and
distributing the remote SG representation to the determined other local PEPs.

7. The method of claim 1 additionally comprises of:
configuring the local SG representation externally from the local PDP; and
distributing the configured local SG representation to the local PDP.

8. The method of claim 1 additionally comprises of:
creating a first security policy in the local network location associating the local node to the SG but not the remote node; and
creating at least one second security policy in the remote network location associating the at least remote node to the SG but not the local node.

9. The method of claim 1 additionally comprises of assigning the local PEP located within the local network location to the local SG representation, the local SG representation having (i) the local network identifier which identifies the local network location within which the local node is located and (ii) a representation of the local node which identifies the local remote node, but lacking the representation of the remote node which identifies the remote node, the PEP further responsible for implementing network security functions.

10. The method of claim 9 wherein the step of assigning further comprises configuring the PEP with the local SG representation.

11. The method of claim 10 wherein the step of configuring comprises:
configuring the local SG representation externally from the PEP; and
distributing the configured local SG representation to the PEP.

12. The method of claim 11 wherein the step of configuring comprises triggering a request message to be configured with the configured local SG representation in response to communications being sent from the local node to the remote node.

13. A method of claim 1 additionally comprises of:
generating a key for the SG; and
distributing the key to the local PEP located within the local network location and PEP located within the remote network location.

14. An apparatus to secure message traffic in a data network by distributing security policies, the data network comprising a local network location having at least one local node located at the location, and a remote network location having at least one remote node, the local and remote nodes being members of at least one Security Group (SG), the SG also including a network identifier for the location of the local node and a network identifier for the location of the remote node, the apparatus comprising:
a determination unit to determine that a new local SG representation exists, the local SG representation including a network identifier for local nodes in the SG but not including a representation of the remote node in the SG;
a sending unit in communications with the determination unit to send a request message from the local PDP to a remote PDP associated with the remote network location to inform the remote PDP of receipt of a new SG representation, the request message including an identifier of the SG but not identities of the members of the SG;
a receiving unit receiving a reply message from a remote PDP, the reply message including a remote network identifier for remote nodes associated with the remote PDP without identifying the remote node; and
a distributing unit in communications with the receiving unit to distribute the local SG representation and the remote network identifier to a local Policy Enforcement Point (PEP), to enable the local PEP to apply security functions to traffic between the local and remote nodes.

15. Computer program product for securing message traffic in a data network by distributing security policies, the data network having a local network location with a local node located therein and at least one remote network location with at least one remote node located therein, the local node and the at least one remote node being associated with and members of at least one Security Group (SG), the computer program product comprising a computer readable medium having a computer readable program, wherein the computer readable program when executed on computer causes the computer to:
determine that a new local SG representation exists, the local SG representation including a network identifier for local nodes in the SG but not including a representation of the remote node in the SG;
send a request message from the local PDP to a remote PDP associated with the remote network location to inform the remote PDP of receipt of a new SG representation, the request message including an identifier of the SG but not identities of the members of the SG;
receive a reply message from a remote PDP, the reply message including a remote network identifier for remote nodes associated with the remote PDP without identifying the remote node; and
distribute the local SG representation and the remote network identifier to a local Policy Enforcement Point (PEP), to enable the local PEP to apply security functions to traffic between the local and remote nodes.
